(19) United States
(12) Patent Application Publication
(10) Pub. No.: US 2017/0165967 A1
(43) Pub. Date: Jun. 15, 2017

(54) Liquid Ejecting Head, Liquid Ejecting Head Unit, Liquid Ejecting Apparatus, and Manufacturing Method of Flow Channel Member

(71) Applicant: Seiko Epson Corporation, Tokyo (JP)

(72) Inventor: Ryota Kinoshita, Matsumoto-shi (JP)

(21) Appl. No.: 15/376,996

(22) Filed: Dec. 13, 2016

(30) Foreign Application Priority Data
Dec. 15, 2015 (JP) 2015-243834

(51) Int. Cl. B41J 2/14

(52) U.S. Cl. CPC B41J 2/1433

(57) ABSTRACT

A liquid ejecting head includes a first flow channel member that is formed using a liquid crystal polymer and is provided with a first flow channel for flowing liquid therethrough and a longitudinal fixing region, a second flow channel member that is joined to the fixing region of the first flow channel member and is provided with a second flow channel for flowing liquid therethrough, and a nozzle for ejecting liquid from the first flow channel and the second flow channel, and a linear expansion coefficient in a longitudinal direction of the fixing region is smaller than a linear expansion coefficient in a lateral direction of the fixing region.

### BACKGROUND

1. Technical Field

The present invention relates to a liquid ejecting head, that is provided with a flow channel member through which liquid flows, a liquid ejecting head unit, and a manufacturing method of a flow channel member.

2. Related Art

Image recording apparatuses such as ink jet type printers and ink jet type plotters are examples of liquid ejecting apparatuses that are provided with liquid ejecting heads, but in recent years, liquid ejecting apparatuses have also been applied to various manufacturing apparatuses to make use of the feature of being able to accurately land a very small quantity of liquid in a predetermined position. For example, liquid ejecting apparatuses have been applied to display manufacturing apparatuses that manufacture color filters such as liquid crystal displays, electrode formation apparatuses that form electrodes such as organic electro luminescence (EL) displays and field emitting displays (FEDs), and chip manufacturing apparatuses that manufacture biochips (biochemical elements). Further, liquid form ink is ejected in recording heads for image recording apparatuses, and solutions of each color material of Red (R), Green (G), and Blue (B) are ejected in color material ejecting heads for display manufacturing apparatuses. In addition, liquid form electrode materials are ejected in electrode material ejecting heads for electrode formation apparatuses, and solutions of living organic material are ejected in living organic material ejecting heads for chip manufacturing apparatuses. In addition, there are also liquid ejecting apparatuses that are provided with a liquid ejecting head unit in which a plurality of liquid ejecting heads are disposed and unitized.

There are liquid ejecting apparatuses in which the above-mentioned liquid ejecting heads are provided with a head case, in which a flow channel is formed in an inner portion, and a hard substrate that is joined to the head case and is formed from stainless steel (SUS), monocrystalline silicon, or the like (for example, JP-A-2006-231678). In this kind of configuration, a liquid that has passed through the flow channel inside the head case is delivered to a pressure chamber via a flow channel that is provided inside the substrate. Further, the liquid inside the pressure chamber is ejected from a nozzle as a result of driving of a piezoelectric device (a type of actuator).

Incidentally, since the above-mentioned head case and substrate are formed from different materials, for example, if the temperature that is applied to the head case and the substrate changes, there is a concern that warping will occur during manufacturing, in a use environment of the liquid ejecting heads, or the like, as a result of a difference in the linear expansion coefficients of the two components. If such warping occurs, defects such as assembly faults of the liquid ejecting heads, or the adhesive that bonds the head case and the substrate, peeling away may arise. In addition, there is also a concern that the landing positions of the liquid ejected onto a recording medium (a type of landing target) from the nozzle will be shifted, and therefore, that the printing quality will decrease.

In order to suppress such defects, JP-A-2006-231678 discloses a liquid ejecting head unit that is formed so that a head case is created using a liquid crystal polymer and so that the linear expansion coefficient in the longitudinal direction of the head case is close to the linear expansion coefficient of a substrate that is formed from silicon. In addition, JP-A-2002-321374 discloses a liquid discharging head in which synthesis of a top plate is improved by forming the top plate using a resin that includes a filler.

However, reducing the linear expansion coefficient of the head case, and improving rigidity in the above-mentioned manner was not sufficient. That is, when heat is applied to the liquid ejecting heads, there is a concern that warping will occur in either a first flow channel member such as a head case, or a second flow channel member such as a substrate, which is joined to the first flow channel member, due to a difference in the linear expansion coefficients thereof.

### SUMMARY

An advantage of some aspects of the invention is to provide a liquid ejecting head, a liquid ejecting head unit and a manufacturing method of a flow channel member in which warping due to changes in temperature is suppressed.

According to an aspect of the invention, there is provided a liquid ejecting head including a first flow channel member that is formed using a liquid crystal polymer and is provided with a first flow channel through which liquid flows, a second flow channel member that is joined to the first flow channel member and is provided with a second flow channel through which liquid flows, and a nozzle through which liquid that has passed through the first flow channel and the second flow channel is ejected, in which a longitudinal fixing region, to which the second flow channel member is fixed, is formed on a fixing surface of the first flow channel member on a second flow channel member side, and a linear expansion coefficient in a longitudinal direction of the fixing region is smaller than a linear expansion coefficient in a lateral direction of the fixing region.

According to the aspect of the invention, it is possible to solidly fix the first flow channel member or the second flow channel member. As a result of this, it is possible to suppress warping of the first flow channel member and the second flow channel member. In addition, when preparing the first flow channel member using injection molding, since it is sufficient as long as the liquid crystal polymer is caused to flow and oriented in the longitudinal direction of the fixing region, the formation of the first flow channel member is easy.

In addition, in the above-mentioned configuration, it is preferable that the first flow channel member be provided with a penetration hole that penetrates through the first flow channel member in a direction that is orthogonal to the fixing surface.

According to this configuration, it is easy to control the direction of flow of the liquid crystal polymer when preparing the first flow channel member using injection molding. As a result of this, it is easy to form a first flow channel member in which the liquid crystal polymer is oriented in the longitudinal direction of the fixing region.

Furthermore, in the above-mentioned configuration, it is preferable that fixing regions be formed on both sides of an opening on a fixing surface side of the penetration hole with the opening interposed therebetween, and that the longitudinal direction of the fixing regions on both sides be aligned to be in the same direction as one another.

According to this configuration, since the first flow channel member and the second flow channel member are fixed on both sides of the penetration hole, the fixing of the first flow channel member and the second flow channel member is more solid.

In addition, in the above-mentioned configuration, it is preferable that the first flow channel member be formed in a state in which a liquid form liquid crystal polymer that flows in from a gate, is solidified, and that the fixing region be provided in a region that is separate from a weldline.

According to this configuration, since the first flow channel member and the second flow channel member are fixed avoiding a region in which the direction of orientation of the liquid crystal polymer is irregular, the fixing of the first flow channel member and the second flow channel member is more solid.

Furthermore, in the above-mentioned configuration, it is preferable that, of the first flow channel member, at least the fixing surface be formed in a longitudinal manner.

According to this configuration, it is easy to set the direction of orientation of the liquid crystal polymer to be along the longitudinal direction of the fixing surface. As a result of this, it is possible to decrease the linear expansion coefficient in the longitudinal direction of the fixing surface, and therefore, it is possible to further suppress warping of the first flow channel member or the second flow channel member.

In addition, in the above-mentioned configuration, it is preferable that a plurality of the fixing regions be provided along the longitudinal direction of the fixing surface, and that the longitudinal direction of each fixing region be aligned to be the longitudinal direction of the fixing surface.

According to this configuration, since the first flow channel member and the second flow channel member are fixed in a plurality of locations, the fixing of the first flow channel member and the second flow channel member is more solid.

In addition, in each of the above-mentioned configurations, it is preferable that a recessed portion in which the fixing surface is recessed, is formed within the fixing region.

According to this configuration, it is easy to set the direction of orientation of the liquid crystal polymer to be along the longitudinal direction of the fixing region.

Furthermore, in each of the above-mentioned configurations, it is preferable that the first flow channel member be formed in a state in which a liquid form liquid crystal polymer that flows in from a gate, is solidified, and that the gate be provided on a fixing surface side.

According to this configuration, it is possible to easily align the direction of orientation of the liquid crystal polymer on the fixing surface in comparison with a case in which the gate is provided on a side that is opposite to the fixing surface.

In addition, in each of the above-mentioned configurations, it is preferable that the first flow channel member be longitudinal in one direction along the fixing surface and be formed in a state in which a liquid form liquid crystal polymer that flows in from a gate, is solidified, and that the gate be provided in an end portion on one side of the first flow channel member in the longitudinal direction.

According to this configuration, it is easy to set the direction of orientation of the liquid crystal polymer to be along the longitudinal direction of the first flow channel member.

Further, according to another aspect of the invention, there is provided a liquid ejecting head unit including a plurality of the liquid ejecting heads having each of the above-mentioned configurations along the lateral direction of the fixing region.

According to this configuration, warping in the lateral direction of the fixing region, which is a direction in which the linear expansion coefficient is comparatively large, is suppressed in comparison with a case in which a liquid ejecting head unit is configured by a single liquid ejecting head.

Further, according to still another aspect of the invention, there is provided a liquid ejecting apparatus including a first flow channel member that is formed using a liquid crystal polymer and is provided with a first flow channel through which liquid flows, a second flow channel member that is joined to the first flow channel member and is provided with a second flow channel through which liquid flows, and a nozzle through which liquid that has passed through the first flow channel and the second flow channel is ejected, in which a longitudinal fixing region, to which the second flow channel member is fixed, is formed on a fixing surface of the first flow channel member on a second flow channel member side, and a linear expansion coefficient in a longitudinal direction of the fixing region is smaller than a linear expansion coefficient in a lateral direction of the fixing region.

According to the aspect of the invention, it is possible to solidly fix the first flow channel member and the second flow channel member. As a result of this, it is possible to suppress warping of the first flow channel member and the second flow channel member. In addition, when preparing the first flow channel member using injection molding, since it is sufficient as long as the liquid crystal polymer is caused to flow and oriented in the longitudinal direction of the fixing region, the formation of the first flow channel member is easy.

In addition, according to still another aspect of the invention, there is provided a manufacturing method of a flow channel member having a longitudinal fixing region in which another member is fixed, the method including introducing a liquid form liquid crystal polymer inside a metal mold from a gate, and orienting the liquid crystal polymer so that a linear expansion coefficient in a longitudinal direction of the fixing region in a state in which the liquid crystal polymer is solidified, is smaller than a linear expansion coefficient in a lateral direction of the fixing region, and solidifying the liquid crystal polymer inside the metal mold.

According to this method, it is possible to easily prepare a flow channel member in which the linear expansion coefficient in a longitudinal direction of the fixing region is smaller than a linear expansion coefficient in a lateral direction of the fixing region.

### BRIEF DESCRIPTION OF THE DRAWINGS

The invention will be described with reference to the accompanying drawings, wherein like numbers reference like elements.

FIG. 1 is a perspective view that describes a configuration of a printer.

FIG. 2 is an exploded perspective view of a recording head unit.

FIG. 3 is a perspective view that describes a configuration of a recording head.

FIG. 4 is a cross-sectional view in which the main parts of the recording head are enlarged.

FIG. 5 is a schematic view in which a head case is viewed from a fixing surface side.

FIG. 6 is a plan view that schematically represents a state in which a liquid crystal polymer flows inside a metal mold of the head case.

FIG. 7 is a cross-sectional view that schematically represents the state in which the liquid crystal polymer flows inside the metal mold of the head case.

FIG. 8 is a cross-sectional view in which the main parts of a recording head in a second embodiment are enlarged.

FIG. 9 is a schematic view in which a head case in the second embodiment is viewed from a fixing surface side.

### DESCRIPTION OF EXEMPLARY EMBODIMENTS

Hereinafter, aspects for implementing the invention will be described with reference to the appended drawings. Additionally, since the embodiments that are mentioned below are preferred specific examples of the invention, various limitations have been applied thereto, but the scope of the invention is not limited to these aspects unless a feature that specifically limits the invention is disclosed in the following description. In addition, in the following description, an ink jet type recording head unit (hereinafter, referred to as a recording head unit), which is a type of liquid ejecting head unit, and an ink jet type printer (hereinafter, referred to as a printer), which is a type of liquid ejecting apparatus, in which such an ink jet type recording head unit is installed, are illustrated as examples.

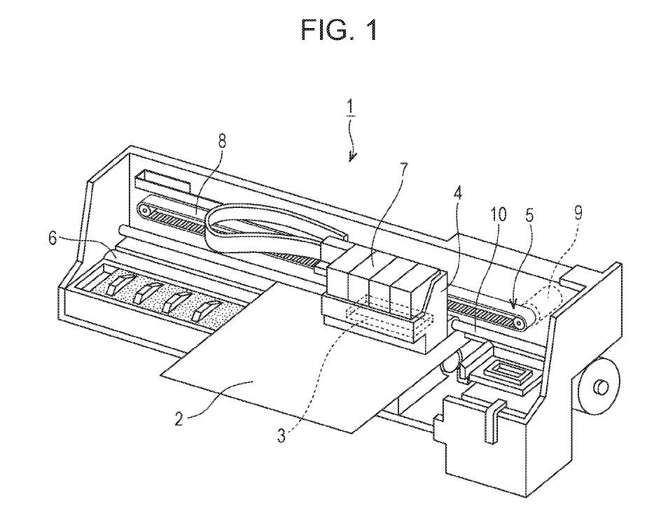

A configuration of a printer 1 will be described with reference to FIG. 1. The printer 1 is an apparatus that performs the recording of images or the like by ejecting an ink (a type of liquid) onto a front surface of a recording medium 2 (a type of landing target) such as recording paper. The printer 1 is provided with a recording head unit 3, a carriage 4 to which the recording head unit 3 is attached, a carriage movement mechanism 5 that moves the carriage 4 in a main scanning direction, a transport mechanism 6 that transfers the recording medium 2 in a sub-scanning direction, and the like. In this instance, the abovementioned ink is retained in ink cartridges 7 as liquid supply sources. The ink cartridges 7 are installed in the recording head unit 3 in a removable manner. Additionally, it is possible to adopt a configuration in which the ink cartridges are disposed on a main body side of the printer, and ink is supplied to the recording head unit from the ink cartridges through an ink supply tube.

The carriage movement mechanism 5 is provided with a timing belt 8. Further, the timing belt 8 is driven by a pulse motor 9 such as a DC motor. Accordingly, when the pulse motor 9 is activated, the carriage 4 reciprocates in the main scanning direction (a width direction of the recording medium 2) guided on a guide rod 10, which is provided in a hanging manner in the printer 1. The position of the carriage 4 in the main scanning direction is detected by a linear encoder (not illustrated in the drawings), which is a type of positional information detection unit. The linear encoder sends a detection signal thereof, that is, an encoder pulse (a type of positional information) to a control portion of the printer 1.

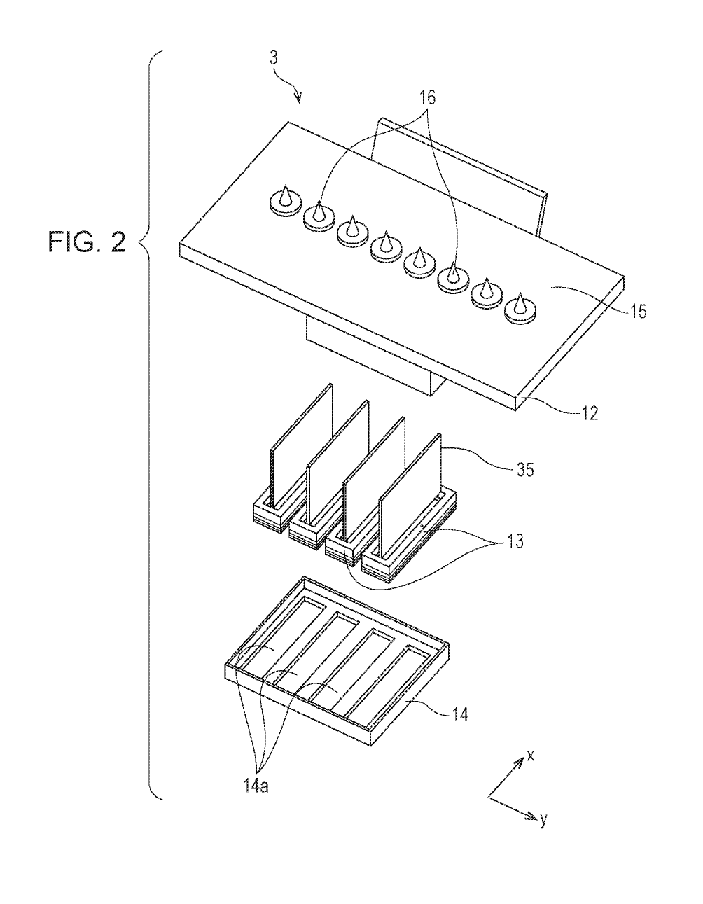

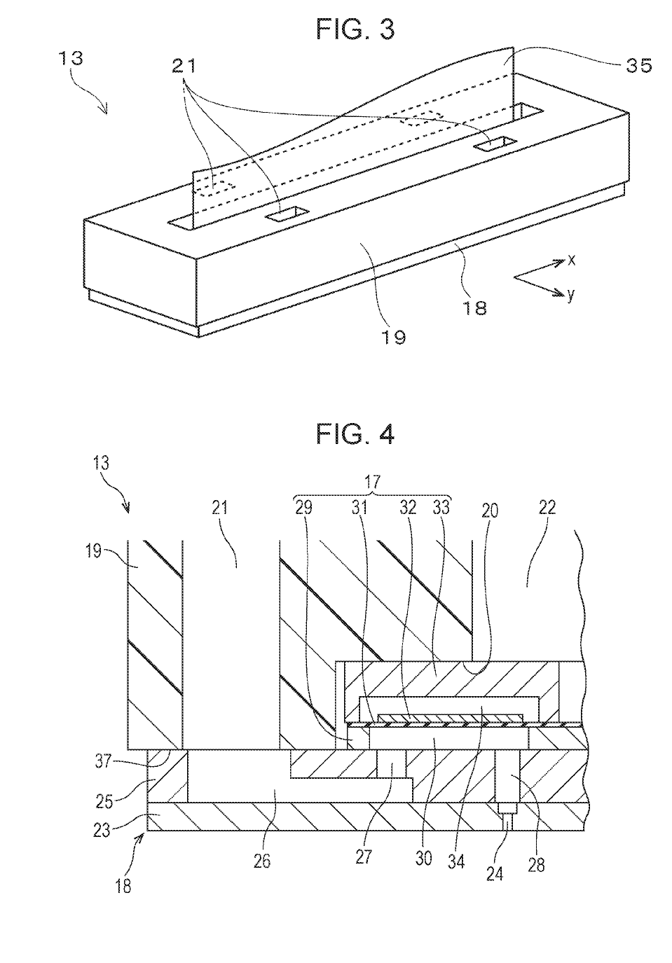

Next, the recording head unit 3 will be described. FIG. 2 is an exploded perspective view of the recording head unit 3. FIG. 3 is a perspective view that describes a configuration of a recording head 13 (a type of liquid ejecting head) that is incorporated in the recording head unit 3. FIG. 4 is a cross-sectional view along the main scanning direction in which the main parts of the recording head 13 are enlarged. Additionally, since the configuration of the recording head 13 is largely left-right symmetric in a direction that is orthogonal to the main scanning direction, only a single configuration is represented in FIG. 4. In the recording head unit 3, a holder 12, a plurality of recording heads 13, a fixing plate 14, and the like are stacked together.

The holder 12 is a member that is made from a synthetic resin, and includes a cartridge installation portion 15 on the upper surface thereof. A plurality of ink introduction needles 16 are vertically arranged in the cartridge installation portion 15 in a horizontal manner along the main scanning direction to correspond to ink of each color of ink cartridge 7. The ink introduction needles 16 are hollow needle form members that are inserted inside the ink cartridges 7. The ink that is accumulated inside the ink cartridges 7 is introduced into a flow channel (not illustrated in the drawings) inside the holder 12 via the ink introduction needles 16. Additionally, the configuration that introduces ink inside the holder 12 from the ink cartridges 7 is not limited to a configuration that uses the ink introduction needles 16, and for example, it is possible to adopt a configuration in which porous members that are capable of absorbing ink, are respectively provided on a supply side and a reception side of ink, and ink is delivered and received as a result of the porous members being brought into contact with one another.

A plurality of the recording heads 13 are attached below the holder 12. In the present embodiment, four recording heads 13 are arrange in parallel along the main scanning direction (hereinafter, referred to as a second direction y) in a state in which the longitudinal directions thereof are aligned in a direction (hereinafter, referred to as a first direction x) that is orthogonal to the main scanning direction. Each recording head 13 is adhered and fixed to the fixing plate 14 in a state in which the position thereof is mutually determined. The fixing plate 14 is a plate material that is formed using stainless steel (SUS), or the like, and protrudes the lower surfaces and the side surfaces of the recording heads 13. Four openings 14a, which expose a nozzle 24 of each recording head 13, are formed in the fixing plate 14 to correspond to each recording head 13. Additionally, the number of the recording heads 13, which are attached to the recording head unit 3, is not limited to four, and it is sufficient as long as there is one or more.

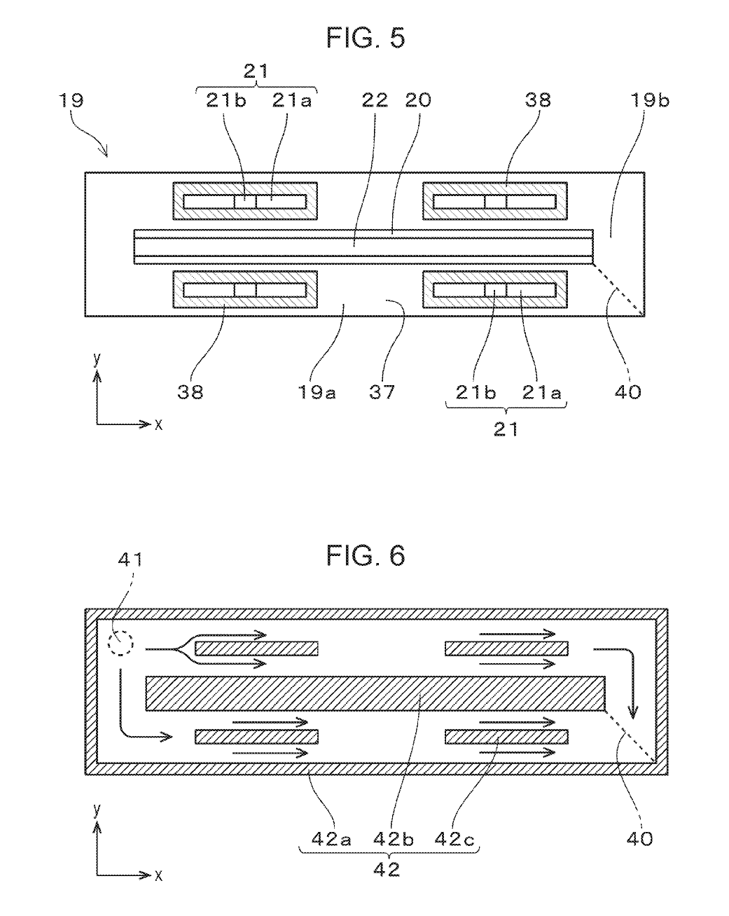

Next, a configuration of the recording head 13 will be described. As shown in FIGS. 3 and 4, the recording head 13 in the present embodiment is attached to a head case 19 (corresponds to a first flow channel member of the invention), which is a type of flow channel member, in a state in which an actuator unit 17 and a flow channel unit 18 are stacked together. Additionally, FIG. 5 is a schematic view in which the head case 19 is viewed from a lower surface (that is, a fixing surface 37 to the flow channel unit 18 (or more specifically, a communication substrate 25)) side. In addition, for convenience of description, the stacking direction of each member will be described as the up-down direction.

The head case 19 in the present embodiment is a box form member that is longitudinal along the first direction x and is formed using a liquid crystal polymer. For example, the aspect ratio (in the present embodiment, the dimension in the first direction x/the dimension in the second direction y) of the head case 19 is set to be 5 to 10. As shown in FIGS. 3 to 5, liquid introduction channels 21 (correspond to first flow channels of the invention), through which ink flows, are formed in inner portions of the head case 19. The liquid introduction channels 21 are flow channels that connect the flow channels inside the holder 12 with common liquid chambers 26, which will be mentioned later. In the present embodiment, two liquid introduction channels 21 are formed in each long edge portion 19a that is formed on both sides in the second direction y with an accommodation space 20 and a penetration space 22, which will be mentioned later, interposed therebetween. That is, a total of four liquid introduction channels 21 are formed in the head case 19. Two liquid introduction channels 21 that are formed in a long edge portion 19a, are disposed along the first direction x.

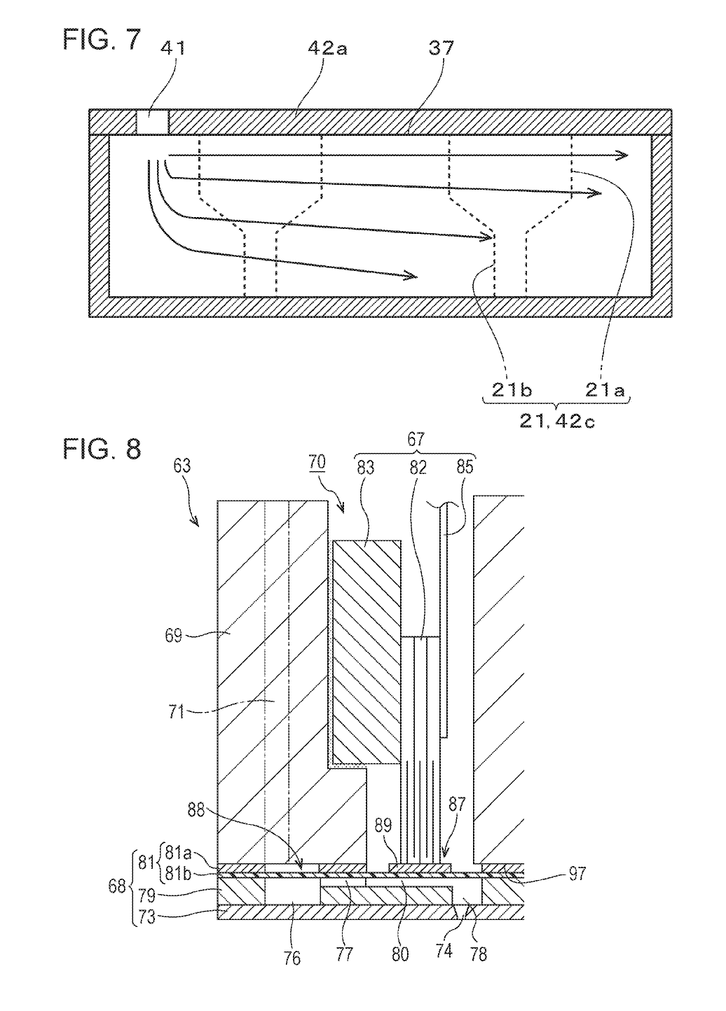

The dimension in the first direction x of each liquid introduction channel 21 is formed so that an opening on a lower surface (that is, the fixing surface 37) side to which the flow channel unit 18 is fixed, is larger than an opening on an upper surface side, which is the surface of a holder 12 side (refer to FIGS. 5 and 7). In other words, the width of the flow channels of the liquid introduction channels 21 in the longitudinal direction of the head case 19 spreads from an upstream side toward a downstream side. More specifically, the head case 19 is provided with recessed portions 21a, in which the lower surface (that is, the fixing surface 37) of the head case 19 are recessed up to midway on the upper surface side, and introduction portions 21b that penetrate through to the upper surface side from the recessed portions 21a. Sides of the recessed portions 21a that are opposite to the fixing surface 37 are formed so that the width of the flow channel in the first direction x gradually narrows from the lower surface side toward the introduction portions 21b. In addition, the introduction portions 21b are open to the substantial central portion of the recessed portions 21a in the first direction x.

In addition, as shown in FIGS. 3 to 5, the accommodation space 20 and the penetration space 22, which are longitudinal along the first direction x, are formed in a central portion of the head case 19. The accommodation space 20 is a space in which the actuator unit 17 is accommodated, and is formed in a state of being recessed from the lower surface of the head case 19 up to midway in a plate thickness direction (that is, a direction that is orthogonal to the lower surface) corresponding to the thickness of the actuator unit 17. The penetration space 22 is in communication with a ceiling surface of an upper surface side of the accommodation space 20 and is formed in a state of penetrating through the head case 19 in the plate thickness direction. The dimension in the first direction x of the penetration space 22 is aligned with the dimension of the accommodation space 20 in the same direction. In addition, the dimension in the second direction y of the penetration space 22 is formed to be smaller than the dimension of the accommodation space 20 in the same direction. A flexible cable 35 (a type of wiring member) that supplies a driving signal to a piezoelectric device 32 (to be mentioned later), is disposed in the penetration space 22 and the accommodation space 20. Additionally, as shown in FIGS. 2 and 3, the flexible cable 35 extends from the upper surface opening of the penetration space 22 up to the outer side of the recording head 13, and is connected to a control substrate, which is provided inside the holder 12 and is not illustrated in the drawings. In addition, the accommodation space 20 and the penetration space 22 correspond to the penetration hole of the invention.

The flow channel unit 18 (or to explain in more detail, the communication substrate 25) is connected to the lower surface of the head case 19. That is, the lower surface of the head case 19 corresponds to the fixing surface 37 to which the communication substrate 25 is joined. Further, among the regions of the fixing surface 37, a region to which the communication substrate 25 is fixed using an adhesive, a screw, or the like, corresponds to a fixing region 38. Additionally, since the head case 19 is formed to be longitudinal along the first direction x, the fixing surface 37 is also longitudinal along the first direction x in the same manner. In addition, in the present embodiment, an epoxy-based adhesive having a low moisture permeability is used in the fixing of the head case 19 and the communication substrate 25. That is, an epoxy-based adhesive is disposed on the fixing region 38, and the head case 19 and the communication substrate 25 are joined using the epoxy-based adhesive. Additionally, the fixing region 38 of the head case 19 will be mentioned in more detail later.

In addition, among the portions of the head case 19, the long edge portions 19a, which are sections that are formed by side walls of the penetration space 22 and the accommodation space 20 in the second direction y, and extend along the penetration space 22 and the accommodation space 20 in the first direction x, are formed so that the liquid crystal polymer is oriented along this direction of extension (that is, the first direction x). In this instance, the liquid crystal polymer is a material in which the linear expansion coefficient in the direction of orientation is small in comparison with general synthetic resins, and can be set to be closer to the linear expansion coefficient of a metal. For example, a liquid crystal polymer in which the linear expansion coefficient (ambient temperature) in the direction of orientation is 1.8 [10⁻⁶/° C.] and the linear expansion coefficient (ambient temperature) in a direction that is orthogonal to the direction of orientation is 46 [10⁻⁶/° C.], a liquid crystal polymer in which the linear expansion coefficient (ambient temperature) in the direction of orientation is 7.0 [10⁻⁶/° C.] and the linear expansion coefficient (ambient temperature) in a direction that is orthogonal to the direction of orientation is 42 [10⁻⁶/° C.], or the like, is used. In particular, in monocrystalline silicon substrates that are used in flow channel units of general liquid ejecting heads, since there are many in which the linear expansion coefficient is approximately 2.5 to 3.5 [10⁻⁶/° C.], it is desirable that the liquid crystal polymer that is used in a head case that is joined to such a substance, be a substance in which the linear expansion coefficient (ambient temperature) in the direction of orientation is 7.0 [10⁻⁶/° C.] or less. Additionally, at short edge portions 19b, which are formed on both sides in the first direction x with the accommodation space 20 and the penetration space 22 interposed therebetween, the liquid crystal polymer is oriented along the second direction y.

In this manner, the linear expansion coefficient in the first direction x, which is the longitudinal direction, of the long edge portions 19a of the head case 19 is smaller than the linear expansion coefficient in the second direction y, which is the lateral direction. Therefore, it is possible to set the linear expansion coefficient in the longitudinal direction of the head case 19 to be closer to the linear expansion coefficient of the communication substrate 25, which will be mentioned later, and therefore, it is possible to suppress warping of the head case 19 and the communication substrate 25. As a result of this, it is possible to use an epoxy-based adhesive, for which heating is necessary during adhesion, as the adhesive that bonds the head case 19 to the communication substrate 25. In addition, it is possible to widen the range of environmental temperature at which it is possible to use the recording heads 13.

The flow channel unit 18, which is joined to the lower surface of the head case 19 is a substrate that is longitudinal in the first direction x and in which the communication substrate 25 (corresponds to the second flow channel member of the invention) and a nozzle plate 23 are stacked together. The communication substrate 25 is a plate material made from silicon, and in the present embodiment, is prepared from a monocrystalline silicon substrate in which the crystal plane orientation of the outer surfaces (the upper surface and the lower surface) is set as (110). In addition, the linear expansion coefficient of the communication substrate 25 in the present embodiment is 2.6 [10⁻⁶/° C.]. As shown in FIG. 4, the common liquid chamber 26, which is in communication with the liquid introduction channels 21, and in which ink that is common to each pressure chamber 30 is accumulated, and individual communication channels 27, which individually supply ink from the liquid introduction channels 21 to each pressure chamber 30 via the common liquid chambers 26, are formed in the communication substrate 25 using anisotropic etching. The common liquid chambers 26 are space portions that are longitudinal along the first direction x, and four common liquid chambers 26 are formed to correspond to the four liquid introduction channels 21. A plurality of the individual communication channels 27 are opened in positions of the common liquid chambers 26 that correspond to the pressure chambers 30. That is, a plurality of the individual communication channels 27 are formed along a parallel arrangement direction (that is, the first direction x) of the pressure chambers 30. Each individual communication channel 27 is in communication with an end portion of one side in the longitudinal direction (that is, the second direction y) of a corresponding pressure chamber 30 in a state in which the communication substrate 25 and a pressure chamber formation substrate 29 are joined together. Additionally, the common liquid chambers 26 and the individual communication channels 27 correspond to the second flow channel of the invention.

In addition, nozzle communication channels 28, which penetrate through the plate thickness direction of the communication substrate 25, are formed in positions that correspond to each nozzle 24 of the communication substrate 25. That is, the nozzle communication channels 28 are formed in a plurality along the first direction x to correspond to a nozzle row. The pressure chambers 30 and the nozzles 24 are in communication with one another due to these nozzle communication channels 28. Each nozzle communication channel 28 of the present embodiment is in communication with an end portion of the other side (that is, a side that is opposite to the individual communication channel 27) in the longitudinal direction of a corresponding pressure chamber 30 in a state in which the communication substrate 25 and the pressure chamber formation substrate 29 are joined together. Additionally, the upper surface (a surface on a head case 19 side) of the communication substrate 25 corresponds to a joining surface that is joined to the head case 19. Further, among the regions of the joining surface, a region that corresponds to the fixing region 38, corresponds to an adhesion region that is adhered to the head case 19. The adhesion region in the present embodiment is formed in the periphery of the common liquid chamber 26 when viewed from the upper surface side.

The nozzle plate 23 is a substrate that is made from silicon (for example, a monocrystalline silicon substrate), which is joined to the lower surface (that is, a surface on a side that is opposite to the pressure chamber formation substrate 29) of the communication substrate 25. In the present embodiment, openings that are on the lower surface side of a space that corresponds to the common liquid chamber 26 is sealed by the nozzle plate 23. In addition, a plurality of nozzles 24 (referred to as a nozzle row) are provided in an open manner in the nozzle plate 23 in a linear manner (or in other words, in row form) along the first direction x. In the present embodiment, two nozzle rows are formed to correspond to a row of pressure chambers 30, which are formed in two rows. Pluralities of nozzles 24 that are arranged in parallel (nozzle rows) are provided at regular intervals from a nozzle 24 of one end side to a nozzle 24 of the other end side with a pitch that corresponds to a dot formation density. Additionally, it is also possible to seal the openings that are on the lower surface side of the spaces that correspond to the common liquid chambers using a member such as a compliance sheet that has a flexible property, for example, by joining the nozzle plate to a region of the communication substrate that is separated on the inner side from the common liquid chambers. If configured in this manner, it is possible to make the nozzle plate as small as possible.

As shown in FIG. 4, the actuator unit 17 of the present embodiment is unitized by stacking the pressure chamber formation substrate 29, a vibration plate 31, the piezoelectric device 32, and a sealing plate 33. The actuator unit 17 is formed to a size that can be accommodated inside the accommodation space 20 of the head case 19, and is accommodated inside the accommodation space 20.

The pressure chamber formation substrate 29 is a hard plate material that is made from silicon, and in the present embodiment, is prepared from a monocrystalline silicon substrate in which the crystal plane orientation of the outer surfaces (the upper surface and the lower surface) is set as (110). A plurality of spaces, which should correspond to the pressure chambers 30, are arranged in parallel in the pressure chamber formation substrate 29 along a nozzle row direction (that is, the first direction x) as a result of portions being completely removed in the plate thickness direction by anisotropic etching. The spaces configure the pressure chambers 30 as a result of the lower sections thereof being partitioned by the communication substrate 25, and the upper sections thereof being partitioned by the vibration plate 31. In addition, these spaces, that is, the pressure chambers 30 are formed longitudinally in a direction (that is, the second direction y) that is orthogonal to the nozzle row direction, the individual communication channels 27 are in communication with end portions of one side in the longitudinal direction, and the nozzle communication channels 28 are in communication with end portions of the other side.

The vibration plate 31 is a thin film form member that has an elastic property, and is stacked onto the upper surface (that is, a surface on a side that is opposite to the communication substrate 25) of the pressure chamber formation substrate 29. Upper portion openings of the spaces that should correspond to the pressure chambers 30 are sealed by the vibration plate 31. In other words, the upper surfaces of the pressure chambers 30 are partitioned by the vibration plate 31. Sections of the vibration plate 31 that correspond to the pressure chambers 30 (or to explain in more detail, the upper portion openings of the pressure chambers 30) function as displacement portions that are displaced in a direction of becoming distant from or a direction of approaching the nozzles 24 in accordance with flexural deformation of the piezoelectric devices 32. That is, regions of the vibration plate 31 that correspond to the upper portion openings of the pressure chambers 30 correspond to driving regions in which flexural deformation is allowed. Further, the cubic capacity of the pressure chambers 30 changes depending on the deformation (displacement) of the driving regions (displacement portions). Meanwhile, regions of the vibration plate 31 that are separated from the upper portion openings of the pressure chambers 30 correspond to non-driving regions in which flexural deformation is inhibited.

In addition, for example, the vibration plate 31 is formed from an elastic film that is formed from silicon dioxide (SiO₂) formed on the upper surface of the pressure chamber formation substrate 29, and an insulating body film that is formed from zirconium dioxide (ZrO₂) formed on the elastic film. Further, the piezoelectric devices 32 are respectively stacked on the insulating film (a surface of the vibration plate 31 on a side that is opposite to the pressure chamber formation substrate 29 side) in regions (that is, the driving regions) that correspond to each pressure chamber 30. Additionally, it is possible to adopt a configuration in which the pressure chamber formation substrate and the vibration plate are integral. That is, it is possible to adopt a configuration in which an etching process is carried out from the lower surface side of the pressure chamber formation substrate, the pressure chambers are formed by allowing thin wall sections having low plate thickness, to remain on the upper surface side, and the thin wall sections function as the vibration plate.

The piezoelectric devices 32 of the present embodiment are so-called flexural mode piezoelectric devices. A plurality of the piezoelectric devices 32 are arranged in parallel along the first direction x to each correspond to a nozzle 24. In each piezoelectric device 32, for example, a lower electrode layer that corresponds to an individual electrode, a piezoelectric body layer, and an upper electrode layer that corresponds to a common electrode, are sequentially stacked on the vibration plate 31 in order from the top. Additionally, it is possible to set the lower electrode layer as the common electrode and the upper electrode layer as the individual electrode depending on a driving circuit and the convenience of wiring. When an electric field depending on a difference in potential between the two electrodes is applied between the lower electrode layer and the upper electrode layer, the piezoelectric devices 32, which are configured in this manner, are flexurally deformed in a direction of becoming distant from or a direction of approaching the nozzles 24.

As shown in FIG. 4, the sealing plate 33 is a substrate in which a piezoelectric device accommodation space 34, which is capable of accommodating the piezoelectric device 32, is formed. The sealing plate 33 is joined onto the vibration plate 31 in a state in which the piezoelectric device 32 is accommodated inside the piezoelectric device accommodation space 34. Additionally, it is also possible to adopt a flat plate form sealing plate in which the piezoelectric device accommodation space is not formed. In this case, a space that accommodates the piezoelectric device is formed by increasing the thickness of the adhesive that joins the vibration plate and the sealing plate, and surrounding the piezoelectric device with the adhesive. In addition, it is also possible to adopt a configuration in which circuits and wiring such as a driving circuit, are formed on the sealing plate itself.

Further, a recording head 13 that is formed in the above-mentioned manner introduces ink from the ink cartridges 7 to the pressure chambers 30 through the liquid introduction channels 21, the common liquid chamber 26 and the individual communication channels 27. In this state, the piezoelectric devices 32 are driven and the cubic capacities of the pressure chambers 30 are changed by supplying driving signals to the piezoelectric devices 32 from the control portion via the flexible cable 35. As a result of using pressure fluctuations that accompany theses changes in cubic capacity, ink droplets are ejected from the nozzles 24, which are in communication with the pressure chambers 30 via the nozzle communication channels 28.

Next, the fixing region 38, to which the communication substrate 25 of the head case 19 is fixed (that is, adhered by the adhesive) will be described in detail. As shown in FIG. 5, the fixing region 38 of the present embodiment is set in the fixing surface 37 in the periphery of the opening of the liquid introduction channel 21, and is formed in a longitudinal manner along the first direction x. In other words, the recessed portion 21a of the liquid introduction channel 21 is provided inside the fixing region 38. Further, four fixing regions 38 are formed to correspond to the four liquid introduction channels 21. More specifically, two fixing regions 38 are formed in each fixing surface 37 in a long edge portions 19a. Two fixing region 38 that are formed in a long edge portion 19a, are separated in the first direction x. In addition, the long edge direction of each fixing region 38 is aligned with the first direction x. In the above-mentioned manner, since the linear expansion coefficient in the longitudinal direction of the long edge portion 19a is smaller than the linear expansion coefficient in the lateral direction of the long edge portion 19a, the linear expansion coefficient in the longitudinal direction of the fixing region 38 is also smaller than the linear expansion coefficient in the lateral direction of the fixing region 38.

In this manner, as a result of setting the linear expansion coefficient in the longitudinal direction of the fixing region 38 to be small, for example, even if the temperature of the fixing surface 37 changes due to changes in the surrounding environment, or heating of the adhesive, or the like, when the head case 19 and the communication substrate 25 are adhered, for example, deformation in the longitudinal direction of the fixing region 38 is suppressed, and therefore, it is possible to suppress stress that is applied the adhesive. As a result of this, the fixing of the head case 19 and the communication substrate 25 is solid, and therefore, it is possible to suppress warping of the head case 19 and the communication substrate 25. In addition, since the fixing regions 38 are formed on both sides with the opening on the fixing surface 37 side of the accommodation space 20 interposed therebetween, and the longitudinal directions of both of the fixing regions 38 are mutually aligned so as to be in the same direction, the head case 19 and the communication substrate 25 are fixed on both sides of the accommodation space 20. As a result of this, the fixing of the head case 19 and the communication substrate 25 is more solid. Furthermore, since two fixing regions 38 are provided along the longitudinal direction of the fixing surface 37, and the longitudinal directions of each fixing region 38 is aligned with the longitudinal direction of the fixing surface 37, the head case 19 and the communication substrate 25 are fixed solidly in a plurality of locations. As a result of this, the fixing of the head case 19 and the communication substrate 25 is more solid. Further, since it is sufficient as long as liquid crystal polymer is caused to flow and oriented in the longitudinal direction of the fixing region 38 when the head case 19, in which the linear expansion coefficient in the longitudinal direction of the fixing regions 38 is small, is prepared using injection molding, the formation of the head case 19 is easy. Additionally, a manufacturing method of the head case 19 will be mentioned later.

In addition, in the head case 19 in the present embodiment, a weldline 40, which corresponds to a point of convergence of the liquid crystal polymer during injection molding, is formed so as to be disposed in one corner (the lower right corner in FIG. 5) among the four corners of the oblong form fixing surface 37. That is, the weldline 40 is formed in a region that is between a single short edge portion 19b and a single long edge portion 19a. Further, the fixing regions 38 are provided in regions that are separate from the weldline 40. As a result of this, since it is possible to fix the head case 19 and the communication substrate 25 avoiding the weldline 40, which corresponds to a region in which the direction of orientation of the liquid crystal polymer is irregular, the fixing of the head case 19 and the communication substrate 25 is more solid.

Further, in the recording head unit 3 of the present embodiment, since a plurality (four in the present embodiment) of recording heads 13 are provided along the second direction y (that is, the lateral direction of the fixing region 38), warping in the second direction y is suppressed in comparison with a case in which a recording head unit is configured by a single recording head. For example, in a case of a recording head in which the dimension in the first direction x is the same as the dimensions in the first direction x of the recording heads 13 in the present embodiment and the dimension in the second direction y is the same as the dimension when the four recording heads 13 in the present embodiment are lined up in the second direction y, it is easy for warping to occur in the second direction y in which the linear expansion coefficient is comparatively large. In contrast to this, in the recording head unit 3 of the present embodiment, since the dimensions in the second direction y of the individual recording heads 13 are small, warping of the recording heads 13 in the second direction y is suppressed.

Next, the manufacturing method of the head case 19, that is, injection molding will be described. FIG. 6 is a plan view that schematically represents a state in which a liquid crystal polymer flows inside a metal mold 42 for the head case 19 from a gate 41. FIG. 7 is a cross-sectional view that schematically represents the state in which the liquid crystal polymer flows inside the metal mold 42 for the head case 19 from the gate 41. Additionally, the arrows that are shown in FIGS. 6 and 7 represent the directions of flow of the liquid crystal polymer. In addition, in FIG. 7, the fixing surface 37 side is represented as the top, and the cross-sectional shape of the liquid introduction channels 21 (or alternatively, peripheral walls 42c of the metal mold 42, which correspond to the liquid introduction channels 21) are represented using broken lines.

In this instance, the metal mold 42 is a mold that is made from a metal which is a created to match the external form and the internal shapes (that is, the shapes of the accommodation space 20 and the penetration space 22, and the liquid introduction channels 21) of the head case 19. As shown in FIG. 6, the metal mold 42 is provided with a hollow longitudinal outer frame 42a that forms the external form of the head case 19, a central wall 42b that is erected in a height direction to correspond to the accommodation space 20 and the penetration space 22, and the peripheral walls 42c that are provided in the periphery of the central wall 42b to correspond to the liquid introduction channels 21. The central wall 42b is formed in a longitudinal manner in the substantial center of the outer frame 42a along the longitudinal direction of the outer frame 42a. In addition, a total of four peripheral walls 42c are provided, two in a space on one side (the upper side in FIG. 6) that corresponds to the long edge portions 19a that are partitioned by the central wall 42b, and two on the other side (the lower side in FIG. 6). The peripheral walls 42c are formed in a flattened plate form (a spatula form) that is thin in a second direction and longitudinal in a first direction. Furthermore, as shown in FIG. 6, the gate 41, through which liquid form liquid crystal polymer is introduced inside the metal mold 42, is formed in an end portion on one side (the upper side in FIG. 6) in the lateral direction (that is, the second direction y), which is an end portion on one side (the left side in FIG. 6) in the longitudinal direction (that is, the first direction x) of the outer frame 42a. In addition, as shown in FIG. 7, the gate 41 is provided on the fixing surface 37 side (that is, in a section of the outer frame 42a that corresponds to the fixing surface 37).

Firstly, in a liquid crystal polymer introduction process, a liquid form liquid crystal polymer is introduced (or more specifically, press fitted) inside the metal mold 42 from the gate 41, and the liquid crystal polymer is oriented so that the linear expansion coefficient in the longitudinal direction (that is, the first direction x) of the fixing region 38 in a state in which the liquid crystal polymer is solidified, is smaller than the linear expansion coefficient in the lateral direction (that is, the second direction y) of the fixing region 38. More specifically, a liquid form liquid crystal polymer, which is heated to a high temperature (or more specifically, a temperature that is the melting point of the liquid crystal polymer or more) is injected inside the metal mold 42 through the gate 41 from an injection unit which is not illustrated in the drawings. As shown in FIG. 6, the liquid form liquid crystal polymer that is caused to flow inside the metal mold 42 through the gate 41, fills the inside of the metal mold 42 as a result of flowing toward a position (that is, the corner that is on the other side in the first direction x, and on the other side in the second direction y) inside the metal mold 42 that forms an opposite angle to the gate 41. At this time, as shown by the arrows in FIG. 6, as a result of the flow being divided by the central wall 42b, the liquid form liquid crystal polymer respectively flows toward a space on one side and a space on the other side that correspond to the long edge portions 19a, which are partitioned by the corresponding central portion. In addition, as a result of the flow being divided by the peripheral walls 42c, the liquid form liquid crystal polymer that flows in the spaces that correspond to the long edge portions 19a, flows toward spaces on one side and spaces on the other side that are partitioned by the corresponding peripheral walls 42c. In this manner, since the widths of the spaces in which the liquid form liquid crystal polymer flows are narrowed by the central wall 42b and the peripheral walls 42c, it is possible to align the flow of the liquid form liquid crystal polymer in these regions to a single direction. That is, in the spaces inside the metal mold 42 that correspond to long edge portions 19a, the central wall 42b and the peripheral walls 42c function as rectifier plates, and therefore, it is possible to make it easy to align the flow of the liquid form liquid crystal polymer to the first direction x. In particular, since the peripheral walls 42c are formed inside the fixing regions 38 when viewed from the fixing surface 37 side, and in addition, since the peripheral walls 42c are longer at the top (that is, on the fixing surface 37 side) than the bottom (that is, on the side that is opposite to the fixing surface 37), it is possible to make it easy to align the flow of the liquid form liquid crystal polymer to the first direction x in the regions that correspond to the fixing regions 38.

In addition, as shown by the arrows in FIG. 7, the liquid form liquid crystal polymer that flows inside the metal mold 42 through the gate 41 flows toward the top (that is, the fixing surface 37 side) and the bottom (that is, the side that is opposite to the fixing surface 37) while flowing toward an end portion on one side and an end portion on the other side in the longitudinal direction having the gate 41. Further, the inner portion of the metal mold 42 is filled with the liquid form liquid crystal polymer from the bottom. At this time, among regions of the bottom of the metal mold 42, it is easy for the flow of the liquid form liquid crystal polymer to become irregular in the end portions on one side (the left side in FIG. 7) in the longitudinal direction. Therefore, it is easy for the direction of orientation to become irregular in a state in which the liquid crystal polymer is solidified. That is, in a state in which the head case 19 is formed, it is easy for regions in which the orientation is irregular to be formed in a portion of the surface that is on a side that is opposite to the fixing surface 37. Meanwhile, in upper regions inside the metal mold 42, since the liquid form liquid crystal polymer flows in a state in which the bottom is filled by the liquid form liquid crystal polymer, it is easy for the flow to flow along the upper surface of the outer frame 42a, which corresponds to the fixing surface 37. That is, it is easy for the flow to flow toward the first direction x. Therefore, in a state in which the head case 19 is formed, it is possible to easily align the direction of the orientation at the fixing surface 37 than the orientation of the surface that is on the side that is opposite to the fixing surface 37.

Further, once the inside of the metal mold 42 is filled by the liquid form liquid crystal polymer, the method migrates to a liquid crystal polymer solidification process that solidifies the liquid form liquid crystal polymer. The liquid crystal polymer is cooled as a result of losing heat to a refrigerant, or the like, through the metal mold 42 in a state of being inside the metal mold 42. After the liquid crystal polymer is cooled and solidified, the metal mold 42 is opened, and the formed head case 19 is removed. Additionally, as shown in FIG. 6, the weldline 40 is formed in a position that forms an opposite angle to the position in which the gate 41 of the head case 19 is present in plan view. In this manner, since the head case 19 is formed in a state in which the liquid form liquid crystal polymer that was caused to flow in from the gate 41, is solidified, it is easy to orient the liquid crystal polymer along a single direction. In particular, in the long edge portions 19a of the head case 19, it is easy to orient the liquid crystal polymer along the first direction x, and therefore, the linear expansion coefficient in the first direction x is smaller than the linear expansion coefficient in the second direction y. That is, it is possible to easily prepare a head case 19 in which the linear expansion coefficient in the longitudinal direction of the fixing region 38 is smaller than the linear expansion coefficient in the lateral direction of the fixing region 38.

In addition, in the present embodiment, since the head case 19 is provided with the accommodation space 20 and the penetration space 22, which penetrate through in a direction that is orthogonal to the fixing surface 37, and the central wall 42b is provided in the metal mold 42 during injection molding, it is easy to control the direction of flow of the liquid crystal polymer. In particular, in the long edge portions 19a, it is easy to orient the liquid crystal polymer along the first direction x. As a result of this, it is easy to form a head case 19 in which the liquid crystal polymer is oriented in the longitudinal direction of the fixing region 38. Additionally, even in a case in which it is not necessary to provide an accommodation space and a penetration space in a head case, it is desirable to form a penetration hole in the head case from a viewpoint of facilitating orientation of the liquid crystal polymer. Furthermore, in the present embodiment, since the head case 19 is provided with the liquid introduction channels 21, and peripheral walls 42c are provided in the metal mold 42 during injection molding, it is easy to further control the direction of flow of the liquid crystal polymer. In particular, among sections of the peripheral walls 42c, since the liquid form liquid crystal polymer that flows on the fixing surface 37 side is rectified in sections that correspond to the recessed portions 21a of the liquid introduction channels 21, it is easy to align the direction of orientation of the liquid crystal polymer of the fixing regions 38 that are provided at the periphery of the recessed portions 21a in the first direction x. That is, it is easy to set the direction of orientation of the liquid crystal polymer to be along the longitudinal direction of the fixing regions 38.

In addition, in the present embodiment, since the fixing surface 37 itself is formed to be longitudinal along the first direction x, it is easy for the liquid form liquid crystal polymer to flow along the longitudinal direction, and therefore, it is easy to set the direction of orientation of the liquid crystal polymer to be along the corresponding direction. As a result of this, it is possible to decrease the linear expansion coefficient in the longitudinal direction of the fixing surface 37, and therefore, it is possible to further suppress warping of the recording heads 13. Further, during injection molding, since the gate 41 is provided on the fixing surface 37 side, it is possible to easily align the direction of orientation of the liquid crystal polymer on the fixing surface 37 in comparison with a case in which the gate 41 is provided on a side that is opposite to the fixing surface 37. Moreover, since the gate 41 is provided in an end portion on one side in the longitudinal direction of the head case 19, it is possible to easily align the direction of orientation of the liquid crystal polymer along the longitudinal direction of the head case 19.

Incidentally, the head case 19 in the above-mentioned embodiment is longitudinal along the first direction x, which is one direction along the fixing surface 37, but the invention is not limited to this configuration, and it is sufficient as long as at least the fixing surface is formed in a longitudinal manner. For example, a configuration in which sections other than the fixing surface are not formed in a longitudinal manner, may also be adopted. In addition, in the above-mentioned embodiment, the opening on the fixing surface 37 side of the liquid introduction channels 21 is formed inside the fixing region 38, but the invention is not limited to this configuration. That is, the openings of the liquid introduction channels need not be formed inside the fixing region. In this case, it is possible to provide the recessed portions, in which the fixing surface is recessed, inside the fixing region separately from the liquid introduction channels. If such a configuration is used, in a case in which there are no liquid introduction channels inside the fixing region, it is also possible to easily align the direction of orientation of the liquid crystal polymer.

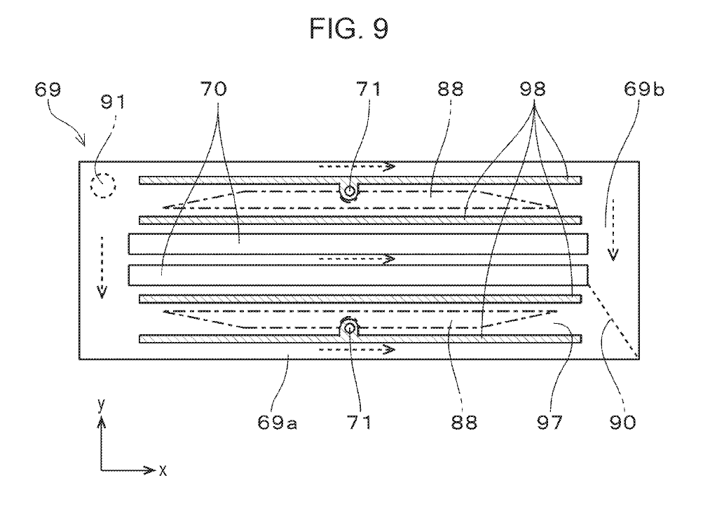

Furthermore, in the above-mentioned embodiment, two fixing regions 38 are disposed separated in the first direction x, but the invention is not limited to this configuration. It is possible to dispose a plurality of two or more fixing regions along the first direction x. In addition, it is possible to set a single longitudinal fixing region along the first direction x by linking a plurality of fixing region. For example, in a second embodiment that is shown in FIGS. 8 and 9, a single longitudinal fixing region 98 along the first direction x is arranged in parallel a plurality of times in the second direction y. In this instance, FIG. 8 is a cross-sectional view in which the main parts of a recording head 63 in the second embodiment are enlarged. In addition, FIG. 9 is a schematic view in which a head case 69 in the second embodiment is viewed from a fixing surface 97 side. Additionally, since the configuration of the recording head 63 is largely left-right symmetric in a direction that is orthogonal to the second direction y, only a single configuration is represented in FIG. 8. In addition, in FIG. 9, a position that corresponds to a gate 91 and a weldline 90 are represented using broken lines, and the directions of orientation (that is, the directions of flow of the liquid crystal polymer during injection molding) of a liquid crystal polymer are represented using broken line arrows. Furthermore, in FIG. 9, a compliance portion 88 is represented using a dashed-dotted line.

As shown in FIG. 8, the recording head 63 in the present embodiment is configured from the head case 69 (corresponds to a first flow channel member of the invention), an actuator unit 67, and a flow channel unit 68. The head case 69 is a box form member that is prepared using a liquid crystal polymer. The flow channel unit 68 (or more specifically, a pressure chamber formation substrate 79 onto which a vibration plate 81 is stacked) is fixed to the lower surface of the head case 69. That is, the lower surface of the head case 69 corresponds to the fixing surface 97 to which the flow channel unit 68 is joined. In addition, an accommodation space 70 (corresponds to a penetration hole of the invention), in which the actuator unit 67 is accommodated, is formed in an inner portion of the head case 69 in a state of penetrating through the head case 69 in the plate thickness direction. As shown in FIG. 9, in the present embodiment, two accommodation spaces 70, which are longitudinal in the first direction x, are lined up in the second direction y. Furthermore, liquid introduction channels 71 (correspond to first flow channels of the invention), which penetrate through the plate thickness direction of the head case 69, are formed in inner portions of the head case 69. The liquid introduction channels 71 in the present embodiment are formed to be oblong along the plate thickness direction of the head case 69.

Additionally, in the head case 69 in the present embodiment, in the same manner as the head case 19 of the above-mentioned first embodiment, the gate 91 during injection molding is disposed in an end portion on one side (the upper side in FIG. 9) in the lateral direction (that is, the second direction y), which is an end portion on one side (the left side in FIG. 9) in the longitudinal direction (that is, the first direction x) in plan view. Therefore, as shown in FIG. 9, the weldline 90 is formed in a position that forms the opposite angle to a position in which the gate 91 is present. Further, in long edge portions 69a, which are formed on both sides in the second direction y with the accommodation space 70 interposed therebetween, the liquid crystal polymer is oriented along the first direction x. In addition, in short edge portions 69b, which are formed on both sides in the first direction x with the accommodation space 70 interposed therebetween, the liquid crystal polymer is oriented along the second direction y. Additionally, the fixing region 98 in the present embodiment will be mentioned in more detail later.

As shown in FIG. 8, the actuator unit 67 is configured by a plurality of piezoelectric devices 82, which are lined up in comb tooth form, a flexible cable 85 that supplies driving signals to the piezoelectric devices 82 from a driving substrate, and a fixing plate 83 that fixes end portions of one side of the piezoelectric devices 82. The piezoelectric devices 82 of the present embodiment, are so-called longitudinal vibration mode piezoelectric devices. Among portions of the piezoelectric devices 82, the tip end surfaces of the free end portions, which are not fixed to the fixing plate 83, are joined to an island portion 89 (the vibration plate 81), which will be mentioned later. Further, it is possible to eject ink from nozzles 74 as a result of expanding and contracting the cubic capacities of pressure chambers 80 by causing the piezoelectric devices 82 to expand and contract due to the application of driving signals.

The flow channel unit 68 is a substrate that is longitudinal along the first direction x, and is provided with the pressure chamber formation substrate 79, the vibration plate 81, which is stacked onto the upper surface (a surface that is on the head case 69 side) of the pressure chamber formation substrate 79, and a nozzle plate 73, which is joined to the lower surface (a surface that is on the side that is opposite to the head case 69) of the pressure chamber formation substrate 79. Additionally, the pressure chamber formation substrate 79 on which the vibration plate 81 is stacked, corresponds to a second flow channel member of the invention. The pressure chamber formation substrate 79 is a plate material that is made from silicon, and in the present embodiment, is prepared from a monocrystalline silicon substrate in which the crystal plane orientation of the outer surfaces (the upper surface and the lower surface) is set as (110). A series of flow channels (corresponds to a second flow channel of the invention), which is formed from a common liquid chamber 76, individual communication channels 77, and the pressure chambers 80, is provided on the pressure chamber formation substrate 79. The common liquid chamber 76 is a space portion that is longitudinal along the first direction x (that is, a nozzle row direction). The liquid introduction channels 71 are in communication with the common liquid chamber 76. The individual communication channels 77 are narrowed portions having small flow channel widths that are in communication with each pressure chamber 80 and the common liquid chamber 76. The pressure chambers 80 are space portions that are longitudinal along the second direction y (that is, a direction that is orthogonal to a nozzle row), and are in communication with the nozzles 74 through nozzle communication channels 78. In the same manner as that of the above-mentioned first embodiment, the nozzle plate 73 is a substrate that is made from silicon in which a plurality of nozzles 24 are opened in linear manner along the first direction x.

The vibration plate 81 in the present embodiment is formed to have a double structure in which an elastic body 81b is stacked on the outer surface of a support plate 81a. For example, the vibration plate 81 is prepared by laminating a stainless steel plate, which is a type of metal plate, as the support plate 81a, and a resin film as the elastic body 81b on the outer surface of the support plate 81a. The compliance portion 88, which seals a diaphragm portion 87 that changes the cubic capacities of the pressure chambers 80, and the top of the common liquid chamber 76, is provided on the vibration plate 81. The diaphragm portion 87 is prepared by partially removing the support plate 81a in regions that face the pressure chambers 80 using etching, or the like. That is, the diaphragm portion 87 is formed from the island portions 89, to which the tip end surfaces of the free end portions (the end portions that are on a side that is opposite to the side that is fixed to the fixing plate 83) of the piezoelectric devices 82 are joined, and thin wall elastic portions that surround the island portions 89. The compliance portion 88 is prepared by removing the support plate 81a in portions that face an opening surface above the common liquid chamber 76 using etching, or the like. As shown in FIG. 9, the compliance portion 88 is formed in a longitudinal manner along a first direction. Using the compliance portion 88, it is possible to absorb pressure fluctuation in the ink of the common liquid chamber 76. That is, the compliance portion 88 functions as a damper that absorbs pressure fluctuations of the common liquid chamber 76.

Further, the recording head 63 in the present embodiment introduces ink from ink cartridges to the pressure chambers 80 through the liquid introduction channels 71, the common liquid chamber 76 and the individual communication channels 77. In this state, the free end portions of the piezoelectric devices 82 are caused to expand and contract and the cubic capacities of the pressure chambers 80 are changed by supplying driving signals to the piezoelectric devices 82 from the control portion via the flexible cable 85. Ink is ejected from the nozzles 74 through the nozzle communication channels 78 using the pressure fluctuations that accompany the changes in cubic capacity.

Next, the fixing regions 98, to which the pressure chamber formation substrate 79, onto which the head case 69 and the vibration plate 81 are stacked, is adhered will be described in detail. As shown in FIG. 9, in the long edge portions 69a, the fixing regions 98 in the present embodiment extend further up to the outer side in the first direction x than a region that corresponds to the compliance portion 88 along the first direction x. In addition, in the respective long edge portions 69a, the fixing regions 98 are formed in regions between the accommodation spaces 70 and the compliance portions 88, and regions that are further on the outer sides in the second direction y than the compliance portion 88. That is, four fixing regions 98 are formed on the fixing surface 97. In the present embodiment, the respective fixing regions 98 are arranged in parallel along the second direction y. In addition, a section of the fixing regions 98 that are formed further on the outer side in the second direction y than the compliance portion 88 is formed protruding on the liquid introduction channel 71 side in a manner that surrounds the periphery of the corresponding liquid introduction channel 71. In the above-mentioned manner, in the long edge portions 69a, since the liquid crystal polymer is oriented along the first direction x, each fixing region 98 extends along the direction of orientation of the liquid crystal polymer. That is, the linear expansion coefficient in the longitudinal direction of the fixing regions 98 is smaller than the linear expansion coefficient in the lateral direction of the fixing regions 98. As a result of this, even if the temperature of the fixing surface 97 changes, deformation in the longitudinal direction of the fixing regions 98 is suppressed, and therefore, it is possible to reduce the stress that is applied to the adhesive. As a result of this, the fixing of the head case 69 and the pressure chamber formation substrate 79 is solid, and therefore, it is possible to suppress warping of the head case 69 and the pressure chamber formation substrate 79. Additionally, since the other configurations are the same as those of the above-mentioned first embodiment, description thereof will be omitted.

Incidentally, in each of the above-mentioned embodiments, another member (a fixing partner such as the communication substrate 25 in the first embodiment, and the pressure chamber formation substrate 79 in the second embodiment) that is connected to the fixing surface of the head case is created using a monocrystalline silicon substrate, but the invention is not limited to this configuration. For example, it is possible to create the communication substrate 25 in the first embodiment or the pressure chamber formation substrate 79 in the second embodiment using stainless steel (SUS), or the like. Further, as the liquid crystal polymer that forms the head case, it is desirable to adopt a substance in which the linear expansion coefficient in the direction of orientation is close to the linear expansion coefficient of the other member that is joined to the fixing surface.

In addition, in each of the above-mentioned embodiments, an adhesive is used in the joining of the head case and the other member in the fixing region, but the invention is not limited to this configuration. For example, it is also possible to adopt a configuration in which a plurality of projecting portions for caulking are erected from the head case throughout the fixing region, and both members a joined by performing caulking in a state in which the tip end of the projecting portions are inserted through the other member. In addition, it is also possible to adopt a configuration in which a plurality of holes for screws are provided throughout the fixing region, and both members are joined by tightening screws via the other member. In either case, since the linear expansion coefficient in the longitudinal direction of the fixing region is smaller than the linear expansion coefficient in the lateral direction of the fixing region, deformation in the longitudinal direction of the fixing region is suppressed, and therefore, it is possible to suppress warping of the head case and the other member.

Furthermore, in each of the above-mentioned embodiments, a recording head unit that is provided with a plurality of recording heads is illustrated by way of example, but the invention is not limited to this configuration. The invention can also be applied to a recording head unit that is only provided with a single recording head. That is, it is also possible to adopt a configuration in which a single recording head is provided in a holder. In addition, in each of the above-mentioned embodiments, the gate during injection molding of the head case is disposed in one corner among the four corners of the fixing surface, but the invention is not limited to this configuration. As long as it is possible to orient the liquid crystal polymer along the longitudinal direction of the fixing region, the gate may be disposed in any position. For example, in a short edge portion, it is possible to provide the gate in the substantial center of the fixing surface.

Further, an ink jet type recording head unit and an ink jet type recording head that are installed in an ink jet printer are illustrated by way of example as a liquid ejecting head unit and a liquid ejecting head, but the invention can also be applied to apparatuses that eject liquids other than ink. For example, it is also possible to apply the invention to color material ejecting heads that are used in the manufacturing of color filters such as liquid crystal displays, electrode material ejecting heads that are used in electrode formation such as organic Electro Luminescence (EL) displays, Field Emission Displays (FEDs), and the like, and living organic matter ejecting heads that are used in the manufacturing of biochips (biochemical elements), and the like. In addition, the invention is not limited to a liquid ejecting head, or the like, and can be applied to any flow channel member to which another member is fixed.

What is claimed is:

1. A liquid ejecting head comprising:
a first flow channel member that is formed using a liquid crystal polymer and is provided with a first flow channel for flowing liquid therethrough and a longitudinal fixing region;
a second flow channel member that is joined to the fixing region of the first flow channel member and is provided with a second flow channel for flowing liquid therethrough; and
a nozzle for ejecting liquid from the first flow channel and the second flow channel,
wherein a linear expansion coefficient in a longitudinal direction of the fixing region is smaller than a linear expansion coefficient in a lateral direction of the fixing region.

2. The liquid ejecting head according to claim 1,
wherein the first flow channel member is provided with a penetration hole that penetrates through the first flow channel member in a direction that is orthogonal to a fixing surface where the fixing region is provided with.

3. The liquid ejecting head according to claim 2,
wherein fixing regions are formed on the fixing surface with an opening on the fixing surface interposed therebetween, and
wherein the longitudinal directions of the fixing regions are aligned to be in the same direction as one another.

4. The liquid ejecting head according to claim 1,
wherein the first flow channel member is formed in a state in which a liquid form liquid crystal polymer that flows in from a gate, is solidified, and
wherein the fixing region is provided in a region that is separate from a weldline.

5. The liquid ejecting head according to claim 1,
wherein, of the first flow channel member, at least a fixing surface where the fixing region is provided is formed in a longitudinal manner.

6. The liquid ejecting head according to claim 5,
wherein a plurality of the fixing regions are provided along the longitudinal direction of the fixing surface, and
wherein the longitudinal direction of each fixing region is aligned to be the longitudinal direction of the fixing surface.

7. The liquid ejecting head according to claim 1,
wherein a recessed portion in which the fixing surface is recessed is formed, within the fixing region.

8. The liquid ejecting head according to claim 1,
wherein the first flow channel member is formed in a state in which a liquid form liquid crystal polymer that flows in from a gate, is solidified, and
wherein the gate is provided on a fixing surface side.

9. The liquid ejecting head according to claim 1,
wherein the first flow channel member is longitudinal in one direction along the fixing surface and is formed in a state in which a liquid form liquid crystal polymer that flows in from a gate, is solidified, and
wherein the gate is provided in an end portion on one side of the first flow channel member in the longitudinal direction.

10. A liquid ejecting head unit comprising:
a plurality of the liquid ejecting heads according to claim 1 along the lateral direction of the fixing region.

11. A liquid ejecting head unit comprising:
a plurality of the liquid ejecting heads according to claim 2 along the lateral direction of the fixing region.

12. A liquid ejecting head unit comprising:
a plurality of the liquid ejecting heads according to claim 3 along the lateral direction of the fixing region.

13. A liquid ejecting head unit comprising:
a plurality of the liquid ejecting heads according to claim 4 along the lateral direction of the fixing region.

14. A liquid ejecting head unit comprising:
a plurality of the liquid ejecting heads according to claim 5 along the lateral direction of the fixing region.

15. A liquid ejecting head unit comprising:
a plurality of the liquid ejecting heads according to claim 6 along the lateral direction of the fixing region.

16. A liquid ejecting head unit comprising:
a plurality of the liquid ejecting heads according to claim 7 along the lateral direction of the fixing region.

17. A liquid ejecting head unit comprising:
a plurality of the liquid ejecting heads according to claim 8 along the lateral direction of the fixing region.

18. A liquid ejecting head unit comprising:
a plurality of the liquid ejecting heads according to claim 9 along the lateral direction of the fixing region.

19. A liquid ejecting apparatus comprising:
a first flow channel member that is formed using a liquid crystal polymer and is provided with a first flow channel through which liquid flows;
a second flow channel member that is joined to the first flow channel member and is provided with a second flow channel through which liquid flows; and
a nozzle through which liquid that has passed through the first flow channel and the second flow channel is ejected,
wherein a longitudinal fixing region, to which the second flow channel member is fixed, is formed on a fixing surface of the first flow channel member on a second flow channel member side, and
wherein a linear expansion coefficient in a longitudinal direction of the fixing region is smaller than a linear expansion coefficient in a lateral direction of the fixing region.

20. A manufacturing method of a flow channel member having a longitudinal fixing region in which another member is fixed, the method comprising:
introducing a liquid form liquid crystal polymer inside a metal mold from a gate, and orienting the liquid crystal polymer so that a linear expansion coefficient in a longitudinal direction of the fixing region in a state in which the liquid crystal polymer is solidified, is smaller than a linear expansion coefficient in a lateral direction of the fixing region; and
solidifying the liquid crystal polymer inside the metal mold.
